(19) United States
(12) Patent Application Publication
(10) Pub. No.: US 2004/0240509 A1
(43) Pub. Date: Dec. 2, 2004

(54) Coolable window system

(75) Inventors: Robert Parsells, Princeton, NJ (US); Charles Gentile, Plainsboro, NJ (US)

Correspondence Address: PROTEUS PATENT PRACTICE LLC, P.O. BOX 1867, NEW HAVEN, CT, 06508, US

(73) Assignee: Princeton University, Princeton, NJ (US)

(21) Appl. No.: 10/842,362

(22) Filed: May 10, 2004

Related U.S. Application Data
(60) Provisional application No. 60/471,307, filed on May 16, 2003.

(51) Int. Cl. H01S 3/04; H01S 3/08; G01F 23/00

(52) U.S. Cl. 372/103; 372/36

(57) ABSTRACT

The present invention is directed toward a window or foil that transmits incident radiation with high efficiency and that is coupled to a cooling means to dissipate heat from radiation losses occurring within the window. In one aspect the invention provides an energy-transmitting system that includes a nonmetallic window and means for cooling the window. In a second aspect the invention provides a laser assembly including a laser cavity enclosed by a wall that has one or more surfaces, wherein at least one surface includes an actively cooled window of the invention. In various embodiments of both the energy-transmitting system and the laser assembly the window includes a dielectric material, or a semiconducting material such as silicon. In addition a corrosion-resistant coating may be deposited on at least one surface of the window. Among several modalities for cooling the window, favorably the window includes a semiconductor exhibiting a thermoelectric effect and the cooling means implements thermoelectric cooling thereof. The invention additionally provides a method of cooling a window, such as when it is included as part of a laser assembly described herein, that includes providing the assembly and operating a cooling means disposed effectively to cool the window.

### RELATED APPLICATION

This application claims the benefit of priority of provisional application U. S. Ser. No. 60/471,307 filed May 16, 2003.

### GOVERNMENT RIGHTS

The present invention was made with Government support and the Government has certain rights in the invention.

### FIELD OF THE INVENTION

This invention relates to a window or foil that transmits high intensity radiation therethrough and means for cooling the window. More particularly, the invention relates to a window or foil that transmits incident forms of radiation with high efficiency and that is coupled to a cooling means to dissipate heat from radiation losses occurring within the window.

### BACKGROUND OF THE INVENTION

Many installations of equipment or apparatus used in contemporary physics and engineering involve the transmission of high energy, high intensity beams of radiation. Examples of radiation that are generated and transmitted to a destination or target include particulate energy beams such as beta radiation, electrons, protons, neutrons and alpha radiation (⁴He nuclei), as well as electromagnetic radiation such as occurs in the x-ray and gamma ray regions of the spectrum. In such equipment or apparatus, regions of space through which the beams pass are frequently separated from one another by walls or similar physical barriers. For example, particle beams require high vacuum for transmission in order to avoid collisional losses in an originating chamber, but impinge on a target at a finite pressure in another chamber. Such pressure differentials impose a stress on the wall that must be resisted in order to be used in the equipment.

Such chambers must be separated from one another by a barrier window that transmits a beam of radiation with high efficiency, i.e., with minimal loss due to interaction with the material of the window. Especially in the case of particle beams, however, window materials are only partially efficient in transmitting the particles. Collisional loss of the particles with the substance of the windows is dissipated in the form of heat, which can lead to appreciable heating of the wall material. Heating of the material causes additional mechanical stresses that may lead to damage or failure of the material.

In certain applications of the equipment under consideration, the target for the energy beam may be a corrosive gas. This occurs, for example, in certain gas phase lasers being developed for use in laser-induced thermonuclear fusion installations. The corrosive gas is in contact with the window material, and is subject to chemical erosion by the action of the gas on the material. This degradation will weaken the window and lead to its failure as a barrier between the chambers of the apparatus.

As an example, laser fusion installations have attempted to use various metals as windows between the vacuum chamber in which an intense electron beam originates, and a laser cavity containing a corrosive gas as a the lasing medium. Metal windows have several disadvantages when employed in this way. The metals used have relatively high atomic numbers, and so present a high cross section for collisional energy dissipation, thereby heating up excessively. Metals have low specific heats, and so actually change temperature relatively drastically as a result of the collisions. Metals also are subject to corrosion and would not survive long duty cycles in such apparatuses.

This background demonstrates that there is presently a significant need for an actively cooled window or foil. There further is a need for a window that is highly efficient in transmitting high intensity beams of energy, including particulate beams, i.e., a window that minimizes heating as the energy beam traverses the window. There is additionally a need for an effective means for cooling the window, wherein the cooling means interferes only minimally with the transmission of the energy beam through the window. Still further there is a need for a window or foil that effectively resists corrosion when exposed to a corrosive medium. There is also a need for a window that is mechanically sound and can effectively survive static and transitory stresses, including mechanical and thermal stress. There further remains a need for a window having the favorable attributes identified above that readily adapts to incorporation into equipment or apparatus such as a high intensity laser assembly. The present invention addresses these needs.

### SUMMARY OF THE INVENTION

In one aspect the invention provides an energy-transmitting system that includes a nonmetallic window having at least two window surfaces and at least one edge, and means for cooling the window. The window is configured such that it transmits energy impinging on one of its surfaces and exiting from a second surface. It is envisioned that the window has one continuous edge if its overall shape has curved contours such as circular, oval, elliptical, or similar contours; otherwise it has a plurality of edges.

In a second aspect the invention provides a laser assembly including a laser cavity enclosed by a wall that has one or more surfaces, wherein at least one wall surface includes an actively cooled window of an energy-transmitting system described in the preceding paragraph. Furthermore the cavity encloses a lasing medium. It is envisioned that a wall has one continuous surface if its overall cross-sectional shape has curved contours such as circular, oval, elliptical, or similar contours; otherwise the wall has a plurality of surfaces.

In various embodiments, both the energy-transmitting system and the laser assembly may have additional features. In significant embodiments the energy includes an atomic or subatomic particle; in addition the particle may be selected from among a beta particle, a proton, a neutron, and an alpha particle, or any combination of two or more of them. In other significant embodiments the energy includes electromagnetic radiation.

In further advantageous embodiments of the system or the assembly, the window includes a dielectric material or a semiconducting material. More advantageously, a semiconducting material used in the window includes silicon. In yet additional advantageous embodiments of the window or the assembly, a corrosion-resistant coating is deposited on at least one surface of the window. Important advantageous examples of a coating include silicon nitride or carbon.

In still further important embodiments of the energy-transmitting system or the laser assembly the window sustains a pressure differential imposed between a first window surface and a second window surface thereof In certain more important embodiments, the pressure differential is about 2 atmospheres or less.

In yet additional advantageous embodiments of the energy-transmitting system or the laser assembly the window includes a semiconductor exhibiting a thermoelectric effect and the cooling means includes a source of an electrical potential connected to a positive electrode and to a negative electrode. The positive electrode is further connected to one or more edges of the window effectively to impose a positive potential thereon and a negative electrode is further connected to one or more edges of the window, distinct from that connected to the positive electrode, effectively to impose a negative potential thereon. In further advantageous embodiments of the thermoelectrically cooled window, the cooling means additionally includes means for removing heat from edges of the window.

In still additional significant embodiments of the energy-transmitting system or the laser assembly the cooling means includes a cooling fluid in flowing contact with a window surface, as well as means for impelling flow of the fluid across the window surface.

In yet further important embodiments of the energy-transmitting system or the laser assembly, the cooling means includes a closed channel traversing the window, a cooling fluid flowing within the channel, and means for impelling the flow of the fluid through the channel.

In further additional advantageous embodiments of the energy-transmitting system or the laser assembly the cooling means includes a vaporizable liquid contacting a window surface and means for impelling the liquid onto the window surface.

In an additional aspect the invention provides a method of cooling the window of the energy-transmitting system described in the paragraphs above that includes providing the system, and operating the cooling means disposed effectively to cool the window.

In still a further aspect the invention provides a method of cooling a window included as part of a laser assembly described in the paragraphs above that includes providing the assembly and operating a cooling means disposed effectively to cool the window.

In advantageous embodiments of the methods of cooling the window of the energy-transmitting system and of the laser assembly, the window includes a semiconductor exhibiting a thermoelectric effect and the cooling means includes a source of an electrical potential connected to a positive electrode and to a negative electrode. The positive electrode is further connected to one or more edges of the window effectively to impose a positive potential thereon and a negative electrode is further connected to one or more edges of the window, distinct from that connected to the positive electrode, effectively to impose a negative potential thereon. The methods include imposing a positive potential on one or more edges of the window using the positive electrode and imposing a negative potential on or more different edges of the window using the negative electrode. In further advantageous embodiments of the methods, the cooling means additionally includes means for removing heat from edges of the window and the methods further include removing heat from one or more edges of the window.

In other important embodiments of the methods, operating the cooling means includes impelling a cooling fluid into contact with a surface of the window. In certain of these embodiments the cooling fluid is a gas, and in other embodiments the cooling fluid is a vaporizable liquid.

In still additional significant embodiments of the methods the cooling means includes a closed channel traversing the window, and the operation of the cooling means includes impelling the flow of a cooling fluid through the channel.

### BRIEF DESCRIPTION OF THE DRAWINGS

FIG. 1. A schematic representation of an energy-transmitting system.

FIG. 2. A schematic representation of an energy-transmitting system employing a transparent window that exhibits the thermoelectric effect.

FIG. 3. A schematic drawing of a ribbed window.

FIG. 4. A schematic drawing of a window made of silicon.

FIG. 5. Photomicrograph of a window after exposure to fluorine gas.

FIG. 6. A schematic representation of an apparatus for pressure testing of a silicon window.

FIG. 7. A schematic representation of an embodiment of a laser assembly including means for recirculating a cooling gas.

FIG. 8. A schematic representation of an embodiment of a system in which a window is cooled by a circulating liquid.

FIG. 9. A schematic representation of an embodiment of a system in which a window is cooled by a liquid circulating in channels.

### DETAILED DESCRIPTION OF THE INVENTION

The present invention relates to a system that includes a nonmetallic window or foil that facilitates the transmission of energy vectorially in a direction that is approximately normal to a surface of the window, and to means for cooling the window in order to prevent it from overheating as a result of the energy impinges on it. The window thus serves to transmit energy under conditions of continuous, cyclical or repetitively pulsed heating. The invention also relates to a laser assembly that includes a window or foil of the energy-transmitting system as a component in at least one wall of a laser cavity thereof The energy-transmitting window or foil may be actively cooled using the cooling means of the system, and provides high efficiency of transmitting energy, high resistance to corrosion, and high structural and mechanical strength and stability.

As used herein and in the claims, the terms “window” and “foil”, and similar terms or phrases, are used interchangeably to designate broadly a coolable sheet, lamina, membrane, or similar structure that separates two regions of space and that is highly efficient in transmitting radiation.

The window in many, but not all, embodiments may be planar; in additional embodiments it may deviate from planarity by being a convex or concave curved surface in order optimally to accommodate the structural requirements of devices in which the window may be incorporated. In addition it may be divided into subsurfaces each of which may be planar, or may deviate from planarity as just described. The edges of the window may intersect at angles, such as at approximately right angles, when the window is a rectangular or square window. The edges may also intersect at angles other than right angles if the window has an overall shape such as a parallelogram, a trapezoid, or a polygonal shape other than quadrilateral. If the surface is circular, ovoid, elliptical or similarly non-polygonal in overall shape, it will have no specifically defined angles of intersection of edges, but rather a single continuous edge. As noted, the window may be prepared to adopt any shape suitable for an apparatus in which it is to be incorporated. A particular shape of the window does not interfere with its service as an actively cooled energy-transmitting window.

In advantageous embodiments a window is structurally reinforced by support structures dispersed across a surface of the window. As described more fully below, the window is subjected to various thermal and mechanical stresses. The support structure maintains and preserves the mechanical integrity of the window when such stresses are imposed. The support structure may be fabricated of the same material as the window itself, or the support may be made of a different material. The surface regions of the window between any such support structures may themselves be planar, or may in general deviate from planarity by being a convex or concave curved surface in order optimally to accommodate the structural requirements of devices in which the window may be incorporated.

Any equivalent structural design of a window or foil is contemplated within the scope of the present invention.

Many materials may transmit energy with only partial efficiency. Energy that is not transmitted is absorbed by the material. Absorbed energy is dissipated as heat. Upon absorption of energy the material heats up. Increased temperature in a material can adversely affect its properties, including its mechanical strength and its chemical reactivity. In applications envisioned in the present invention it is important to maintain mechanical and chemical integrity of the energy-transmitting window. To this end, the energy-transmitting system includes means for cooling the window in order to maintain it approximately at a desired ambient temperature or within a desired range of ambient temperature. A variety of cooling mechanisms are disclosed herein, as presented more fully below. In this way mechanical and chemical integrity of the window is maintained for an extended period, such that it may serve its intended purpose over such a time period.

Various forms of energy may traverse a window. The energy may be particulate in nature, such as is provided by various particle generators. Particulate forms of energy include atomic particles and subatomic particles, and include particles such as beta particles, electrons, protons, neutrons, or alpha particles, or any combination of two or more of these particles. In an important application envisioned in the present invention, the energy is in the form of electrons provided as a pulsed or continuous electron beam. Alternatively, the energy may be in the form of electromagnetic radiation, including radiation whose wavelength falls anywhere in the electromagnetic spectrum.

The window of the present invention may be fabricated of any nonmetallic material suitable to accomplish the objectives of the window. These objectives include, by way of nonlimiting example, minimizing the extent of absorption of energy as it traverses the window, possessing a high resistance to mechanical stress, possessing a high thermal conductivity, having a high threshold failure stress, and so forth. In common embodiments it is advantageous that the window be made of a dielectric material. In addition, in certain advantageous embodiments, the window may be made of semiconducting material.

In order to minimize the absorption cross-section, there is a preference to select materials made with elements having a low atomic number, Z. Among these is silicon (Si), whose Z is 14; as a result, when considering beta radiation Si attenuates less electron energy (per unit thickness), as compared with a low Z metal such as titanium (Z=22). Si has a relatively high value of specific heat (cₚ, 0.705 J/g-K), so that its temperature rise per absorbed unit of energy will be relatively low. Its mechanical strength is advantageous, having a Young's modulus E measured to lie in the range of about 130 to 190 GPa as determined by various investigators (CRC Handbook of Chemistry and Physics, CRC Press); and a failure stress σ_{f} ranging from about 1,100 to about 7,000 MPa determined by various investigators, and determined along different crystal planes (CRC Handbook of Chemistry and Physics, CRC Press). The thermal conductivity for Si is 1.3 W cm⁻¹ ° C.⁻¹ (CRC Handbook of Chemistry and Physics, CRC Press). As noninventive windows have been made using titanium, the various thermal and mechanical properties for silicon all compare favorably with those for titanium. In addition, Si may be fabricated to be a P or N semiconductor. As described more fully below, this enables use of thermoelectric cooling to displace the excess thermal energy arising within the window. In general, any equivalent material, having advantageous properties such as those identified in this paragraph, may be used to fabricate the window. Such equivalent materials are known to workers of skill in fields such as solid state physics, solid state engineering, materials science, and similar fields related to the field of the present invention

The window or foil may be disposed for use in harsh or corrosive environments. In order to preserve the integrity of the window in such cases, it may be coated with a thin layer of a chemically resistant material that resists the corrosive environment. Such a coating will be thin enough so as not significantly to affect the energy transmitting properties of the window, yet will succeed in shielding the material of the window from corrosion. In advantageous cases, a thin coating may be applied using vacuum vaporization of the coating material from a source and deposition on the window material. Such techniques are well known to workers in fields such as solid state physics, solid state engineering, materials science, and similar fields related to the field of the present invention. Important non-limiting examples of coatings that may be applied in this fashion include silicon nitride (Si₃N₄), silicon carbide (SiC), and carbon (for example as a diamond-like crystal form, including nanocrystalline diamond deposition, or as amorphous carbon. Equivalent refractory coatings known to workers of skill in fields such as solid state physics, solid state engineering, materials science, and similar fields related to the field of the present invention may be employed as the coating. A variety of techniques known to such workers is available for use in depositing the coating. As nonlimiting examples, films may be deposited by physical deposition (Petersen, Proceedings of the IEEE, Vol. 70, No. 5 (1982); F. Markel et al., Semiconductor Fabtech, 10th Ed., 295-299 (1999)), chemical deposition (C. H. F. Peden et al., Phys Rev. B 47, 15622 (1993)), and other methods known to workers of skill in fields such as solid state physics, solid state engineering, materials science, and similar fields related to the field of the present invention.

In many applications envisioned for the window of the present invention a pressure differential arises across the window. This pressure differential may be a steady difference, or it may be transient in response the operation of an apparatus in which it is installed. Resistance to mechanical stress, and identification of the failure stress, is an important attribute of the window employed in the present invention. In certain applications, the pressure differential may be 1 atm or less, or 2 atm or less, or 3 atm or less, or 5 atm or less, or 10 atm or less, or even higher upper limits of a pressure differential. A window or foil is fabricated using materials and features of construction design that successfully preserve the mechanical integrity of the window during normal operation under these conditions.

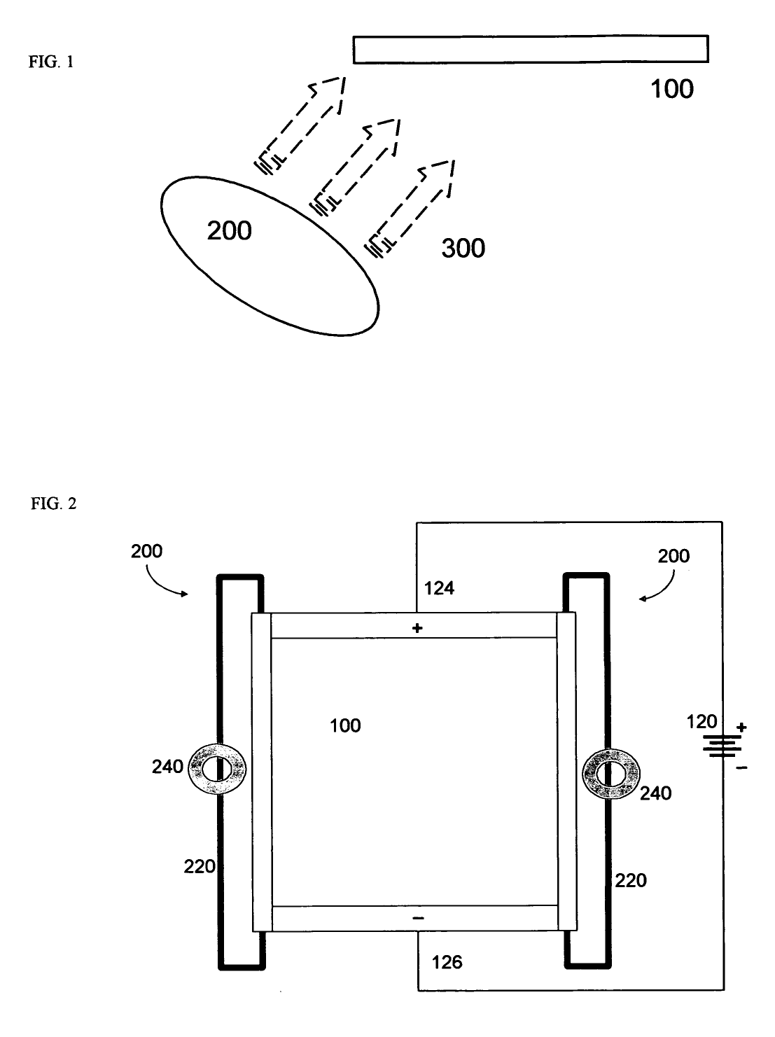

The energy-transmitting system of the present invention also includes means for cooling the window. FIG. 1 provides a schematic representation of the system. The window 100, represented in cross section, is cooled by a cooling means generally represented as 200. The window and the cooling means are coupled in a general fashion to provide the energy-transmitting system of the invention. This general coupling is shown schematically in FIG. 1 by the dashed arrows at 300. The cooling means may be integral to the window in certain embodiments, whereas in other embodiments the cooling means may be a physically separate entity that acts, in various ways, upon the window to cool the window.

As described herein, cooling may be accomplished using various techniques and/or devices. In an important embodiment of the present invention, the energy-transmitting attribute and cooling capability are combined in a single object having no moving parts by employing a transparent window that also exhibits the thermoelectric (Peltier) effect. In this embodiment (see FIG. 2) a semiconductor material is used as the window 100. It includes appropriate juxtapositions of P and N junctions to create semiconductivity and a thermoelectric capability. In order to implement thermoelectric cooling, a source of an electrical potential 120 is connected, respectively, to a positive electrode 124 and to a negative electrode 126. At least one positive electrode is further connected to at least one edge of the window effectively to impose a positive potential thereon, and at least one negative electrode is further connected to at least a second edge of the window effectively to impose a negative potential thereon. In order to cool the window, the potential source is applied across the semiconducting window, which serves to extract heat from the window material to its edges. The heat is finally removed from the edges of the window by a heat-exchanging mechanism 200.

In an alternative cooling means, a cooling fluid is passed along a surface of the window in order effectively to cool it. In an embodiment of this implementation, the fluid is a gas and is circulated across a surface of the window using a circulation system that includes a gas pump and a heat exchanger. In order to cool the window, the gas is caused to pass along the window, absorbing excess heat from the window as it passes over the window. The gas is then caused to circulate to the heat exchanger, which extracts heat from the gas prior to returning the gas to the window.

In a second embodiment by which a fluid flows across the window, a cooling liquid is forced to circulate on or within the window to absorb excess heat, and then pumped to a heat exchanger to remove the excess heat from the liquid. Liquid circulation tubing may be superimposed upon or adjacent the window in ways that minimize transmission of energy across the window, or microchannels may be introduced within the window such that the microchannels are at or proximate to the energy-transmitting region or regions of the window. In order to cool the window, the liquid is pumped through the tubing, or through the microchannels, removing heat from the window as the liquid passes. The liquid is then pumped to a heat exchanger, which extracts the excess heat from the liquid, and the cooled liquid returns to the window.

In an additional embodiment of the cooling means, a vaporizable liquid is sprayed onto the window. Upon contact with the window, the excess heat induces vaporization, and the cooling occurs by extracting the latent heat of vaporization of the liquid from the window. The resulting vapor is collected, for example by maintaining the entire cooling means as a closed system, and condensed in a heat exchanger back to the liquid state. The vaporizable liquid thus acts as a refrigerant liquid. Nonlimiting examples of vaporizable liquids that may be applied to implement this cooling means include various perfluorocarbon solvents, various alcohols and liquid hydrocarbons, other noncorrosive volatile organic liquids, noncorrosive volatile inorganic liquids, and so forth. Any equivalent noncorrosive vaporizable liquid may be employed in this cooling method. Such liquids are known to workers of skill in fields such as chemistry, solid state physics, solid state engineering, materials science, and similar fields related to the field of the present invention. In order to cool the window, a stream or spray of a vaporizable liquid is forced or pumped from a suitable orifice onto the window, where the liquid vaporizes. In many embodiments, the vapor is then collected and condensed back to the liquid form for reuse.

The present invention importantly relates as well to an apparatus in which intense beams of energy are directed from one region of space, such as an energy source, to a second region of space, such as a medium containing an energy-absorbing component that requires the energy input in order to accomplish a given objective. In such an apparatus the actively cooled energy-transmitting system of the invention serves to separate the two regions of space. The actively cooled window serves as a window for the transmission of energy under conditions of continuous, cyclical or repetitively pulsed heating.

As described above, the window used in the present energy-directing apparatus may be prepared to adopt any shape suitable for an apparatus in which it is to be incorporated. A particular shape does not interfere with the service of the window as an actively cooled energy-transmitting window.

The energy-transmitting system as employed in the present energy-directing apparatus includes means for cooling the window in order to maintain it approximately at a desired ambient temperature or within a desired range of ambient temperature. A variety of cooling mechanisms are disclosed herein, as presented more fully above and in the following Examples. In this way mechanical and chemical integrity of the window is maintained for an extended period, such that it may serve its intended purpose over such a time period.

Various forms of energy may traverse a window of the present energy-directing apparatus. The energy may be particulate in nature, such as is provided by various particle generators. Particulate forms of energy include atomic and subatomic particles such as beta particles, electrons, protons, neutrons, or alpha particles, or any combination of two or more of these particles. In an important application envisioned in the present invention, the energy is in the form of electrons provided as a pulsed or continuous electron beam. Alternatively, the energy may be in the form of electromagnetic radiation, including radiation whose wavelength falls anywhere in the electromagnetic spectrum.

The window of the energy-directing apparatus may be fabricated of any nonmetallic material suitable to accomplish the objectives of the window. These objectives include, by way of nonlimiting example, minimizing the extent of absorption of energy as it traverses the window, possessing a high resistance to mechanical stress, possessing a high thermal conductivity, having a high threshold failure stress, and so forth. In common embodiments it is advantageous that the window be made of a dielectric material. In addition, in certain advantageous embodiments, the window may be made of semiconducting material.

In order to minimize the absorption cross-section, there is a preference to select materials made with elements having a low atomic number, Z. Among these is silicon (Si), whose Z is 14; as a result, when considering an electron beam Si attenuates less electron energy (per unit thickness), as compared with a low Z metal such as titanium (Z=22). In general, any equivalent material, having advantageous properties such as those identified in this paragraph, may be used to fabricate the window of the energy-directing apparatus. Such equivalent materials are known to workers of skill in fields such as solid state physics, solid state engineering, materials science, and similar fields related to the field of the present invention

The window of the energy-directing apparatus may be disposed for use in harsh or corrosive environments. In order to preserve the integrity of the window in such cases, it may be coated with a thin layer of a chemically resistant material that resists the corrosive environment. Such a coating will be thin enough so as not significantly to affect the energy transmitting properties of the window, yet will succeed in shielding the material of the window from corrosion. In advantageous cases, a thin coating may be applied using vacuum vaporization of the coating material from a source and deposition on the window material. Such techniques are well known to workers in fields such as solid state physics, solid state engineering, materials science, and similar fields related to the field of the present invention. Important non-limiting examples of coatings that may be applied in this fashion include silicon nitride (Si₃N₄) and carbon (for example as a diamond-like crystal form, including nanocrystalline diamond deposition, or as amorphous carbon. Equivalent refractory coatings known to workers of skill in fields such as solid state physics, solid state engineering, materials science, and similar fields related to the field of the present invention may be employed as the coating. A variety of techniques known to such workers is available for use in depositing the coating.

In many applications envisioned for the window used in the present energy-directing apparatus a pressure differential arises across the window. This pressure differential may be a steady difference, or it may be transient in response the operation of an apparatus in which it is installed. Resistance to mechanical stress, and identification of the failure stress, is an important attribute of the window employed in the present invention. In certain applications, the pressure differential may be 1 atm or less, or 2 atm or less, or 3 atm or less, or 5 atm or less, or 10 atm or less, or even higher upper limits of a pressure differential. A window is fabricated using materials and features of construction design that successfully preserve the mechanical integrity of the window during normal operation under these conditions.

The energy-directing apparatus of the present invention also includes means for cooling the window; this has already been schematically presented in FIG. 1. The cooling means may be integral to the window in certain embodiments, whereas in other embodiments the cooling means may be a physically separate entity that acts, in various ways, upon the window to cool the window.

Cooling may be accomplished using various techniques and/or devices, and their respective methods of using them. These have been disclosed above in the description of the coolable energy-transmitting window.

An important example of an energy-directing apparatus of the invention arises in the case of certain high-intensity laser systems. In order to create a lasing medium, a mixture of krypton (Kr) and difluorine (F₂) is bombarded with electrons emanating from an electron beam source. The laser cavity includes walls assembled to contain the Kr—F₂ mixture within it. At least one of the walls includes an actively cooled energy-transmitting window of the invention. The window is required in order to contain the mixture, as noted, and also because the region of space outside the laser cavity adjacent to the window must be maintained at a high vacuum in order for the electron beam to reach the window without significant attenuation. Optimum transmission of the electron beam through the window and into the cavity is advantageous. This is because energy provided by the electron beam is required to dissociate difluorine into fluorine atom free radicals and form KrF. The KrF dissociates to F₂, emitting light at 248 nm, thus serving as the lasing medium.

The use of difluorine affords the potential for deleterious corrosion occurring to a window material, since F• is highly reactive, and in addition, if any traces of dihydrogen or water vapor are present in the cavity, HF, which is highly corrosive, may form. If, as provided in an important embodiment of the present invention, Si is used as the window material, corrosion may occur according to:

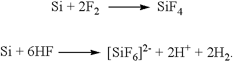

In order to prevent the corrosion of a window or foil that is made using Si, the surface of the window facing the laser cavity is coated by bonding a corrosion-resistant layer to the window. Nonlimiting examples of such corrosion-resistant coatings include silicon nitride (Si₃N₄) and carbon (as nanocrystalline diamond or graphite crystal forms). Silicon nitride has a very low reduction potential and so is resistant to both F₂ and F•. In addition, silicon nitride is essentially non-reactive with HF. Carbon coatings similarly are refractory to the corrosive processes under consideration.

As noted above more generally for windows, use of Si as the material for fabricating the window in this embodiment of a laser assembly is highly advantageous over the use of a metallic window, such as titanium.

The following Examples describe particular embodiments of the invention. They do not limit the full scope of the present invention as disclosed in the specification and claims.

### EXAMPLES

### Example 1

Selection of a Material for Fabrication of a Window or Foil.

Among the properties desired in an actively cooled nonmetallic window of the invention are a low atomic number Z, a high specific heat, a high thermal conductivity, a high Young's modulus E, a high failure stress σ_{f}. These properties should optimally satisfy the needs to prevent significant overheating (even with the operation of a cooling means), and to sustain the stress of having a pressure differential imposed normal to its surface. The pressure differential is due to the fact that, in a laser assembly, the surface facing away from the laser cavity is at high vacuum whereas the surface facing the laser cavity has a lasing gas mixture and expands upon receiving the pulsed energy of an electron beam impinging on the gas. Table 1 presents several physical properties of the first 23 elements in the periodic table. Table 2 presents a collection of measured values for silicon of Young's modulus, the failure stress and Poisson's ratio. Table 3 presents selected thermal properties of silicon.

Upon considering all these factors, use of the information included in Tables 1, 2 and 3, led to the selection of silicon as a material for fabrication of the window.

TABLE 1

| | | | Atomic | | Melting | Boiling | Critical | Ionization | Specific |
|---|---|---|---|---|---|---|---|---|---|
| | | | Weight | Density | point | point | point | potential | heat |
| Z | EI | Name | (a.m.u.) | (g/cm³) | (° C.) | (° C.) | (° C.) | (eV) | (J/gK) |
| 1 | H | Hydrogen | 1.00794 7 | 0.0708 | −259.34 | −252.87 | −240.18 | 13.598 | 14.304 |
| 2 | He | Helium | 4.002602 2 | 0.124901 | −272.2 | −268.93 | −267.96 | 24.587 | 5.193 |
| 3 | Li | Lithium | 6.941 2 | 0.534 | 180.5 | 1342 | | 5.392 | 3.582 |
| 4 | Be | Beryllium | 9.012182 3 | 1.85 | 1287 | 2471 | | 9.323 | 1.825 |
| 5 | B | Boron | 10.811 7 | 2.37 | 2075 | 4000 | | 8.298 | 1.026^{amorphous} |
| 6 | C | Carbon | 12.0107 8 | 2.2670¹⁵* | 4492^{t} | 3842^{s} | | 11.260 | 0.709^{graphite} |
| 7 | N | Nitrogen | 14.00674 7 | 0.807 | −210.00 | −195.79 | −146.94 | 14.534 | 1.040 |
| 8 | O | Oxygen | 15.9994 3 | 1.141 | −218.79 | −182.95 | −118.56 | 13.618 | 0.918 |
| 9 | F | Fluorine | 18.9984032 5 | 1.50 | −219.62 | −188.12 | −129.02 | 17.423 | 0.824 |
| 10 | Ne | Neon | 20.1797 6 | 1.204 | −248.59 | −246.08 | −228.7 | 21.565 | 1.030 |
| 11 | Na | Sodium | 22.989770 2 | 0.97 | 97.80 | 883 | | 5.139 | 1.228 |
| 12 | Mg | Magnesium | 24.3050 6 | 1.74 | 650 | 1090 | | 7.646 | 1.023 |
| 13 | Al | Aluminum | 26.981538 2 | 2.70 | 660.32 | 2519 | | 5.986 | 0.897 |
| 14 | Si | Silicon | 28.0855 3 | 2.3296 | 1414 | 3265 | | 8.152 | 0.705 |
| 15 | P | Phosphorus | 30.973761 2 | 1.82 | 44.15 | 280.5 | 721 | 10.487 | 0.769^{white} |
| 16 | S | Sulfur | 32.066 6 | 2.067 | 115.21 | 444.60 | 1041 | 10.360 | 0.710^{orthorhombic} |
| 17 | Cl | Chlorine | 35.4527 9 | 1.56 | −101.5 | −34.04 | 143.8 | 12.968 | 0.479 |
| 18 | Ar | Argon | 39.948 1 | 1.396 | −189.35 | −185.85 | −122.28 | 15.760 | 0.520 |
| 19 | K | Potassium | 39.0983 1 | 0.89 | 63.38 | 759 | | 4.341 | 0.757 |
| 20 | Ca | Calcium | 40.078 4 | 1.54 | 842 | 1484 | | 6.113 | 0.647 |
| 21 | Sc | Scandium | 44.955910 8 | 2.99 | 1541 | 2836 | | 6.561 | 0.568 |
| 22 | Ti | Titanium | 47.867 1 | 4.5 | 1668 | 3287 | | 6.828 | 0.523 |
| 23 | V | Vanadium | 50.9415 1 | 6.0 | 1910 | 3407 | | 6.746 | 0.489 |

TABLE 2
Material Properties of Silicon

| | Young's Modulus | Failure Stress | |
|---|---|---|---|
| Silicon | E | σ_{f} | Poisson's Ratio |
| Ref | [GPa] | [MPa] | μ |
| 1) | 190 | 7,000 | |
| 2) | | 6,894 | |
| 3) | 150 | 7,000-300 | 0.17 |
| 4) | 150 | | |
| 5) | | 700 | |
| 6) | 132 | | |
| 7) | 190 | | 0.09 |
| 8) | 168 | | 0.066 |
| 9) | 162 | | 0.228 |
| 10) | 170 | | |
| 11) | 169.8 | | 0.062 |
| 12) | 178.6 | | 0.234 |
| 13) <100> | 130 | 3,400-1,100 | 0.064 |
| 13) <110> | 161 | 2,300 | 0.279 |
| 13) <111> | | 1,300 | |

TABLE 3
Thermal Properties of Silicon

| | | |
|---|---|---|
| Bulk modulus | 9.8 · 10¹¹ | dyne/cm² |
| Melting point | 1412° | C. |
| Specific heat | 0.7 | J g⁻¹° C.⁻¹ |
| Thermal conductivity | 1.3 | W cm⁻¹° C.⁻¹ |
| Thermal diffusivity | 0.8 | cm²/s |
| Thermal expansion, linear | 2.6 · 10⁻⁶° | C.⁻¹ |

### Example 2

Design of a Ribbed Silicon Window.

Various duty cycle requirements must be met in order to fashion a serviceable window for use in a laser assembly of the invention. These include an efficiency of transfer of the electron beam energy of greater than 80% @750 keV); a fatigue life of 1×10⁵ cycles (electron beam pulses) in a first stage of testing, and an ultimate fatigue life of 3×10⁸ cycles; and the requirement that structural integrity be maintained during pressure cycling (ΔP=2 atm, f=5 Hz) under a heat load of ˜0.9 W/cm², and exposure to F• (fluorine free radicals).

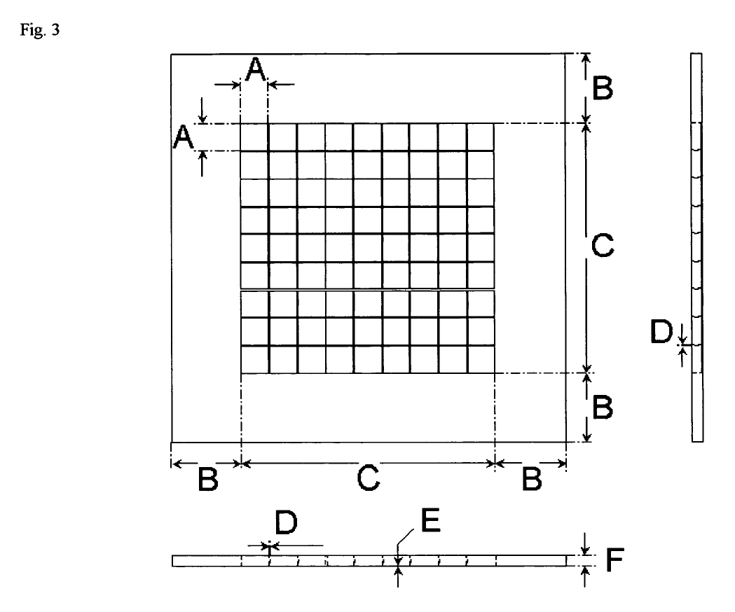

In order to accommodate these needs in a particular embodiment, a ribbed window of silicon was designed whose appearance is shown in FIG. 3. In this embodiment, typical dimensions are given by:

A=1.542±0.002 mm

B=4.0±0.01 mm

C=14.4±0.01 mm

D=0.065±0.002 mm

E=0.019±0.001 mm

F=0.600±0.002 mm.

This window was constructed on order by Corning IntelliSense (Andover, Mass.). The transmitting panes were etched by lithography using a plasma etching process.

### Example 3

Alternative Configuration of a Window or Foil.

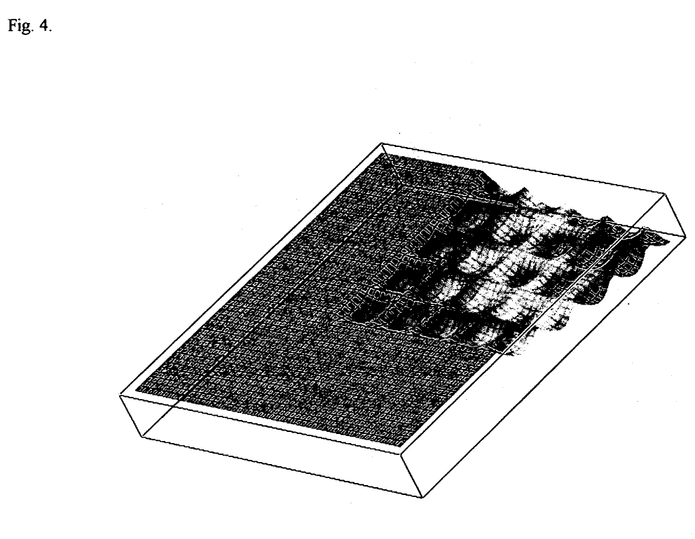

Mathematical modeling was undertaken to provide alternative structures for a window of the invention. The modeling takes into account the various mechanical and thermal stresses anticipated in a window. One embodiment of a resulting design, using the physical properties for silicon, is shown in FIG. 4.

### Example 4

Corrosion Resistant Film.

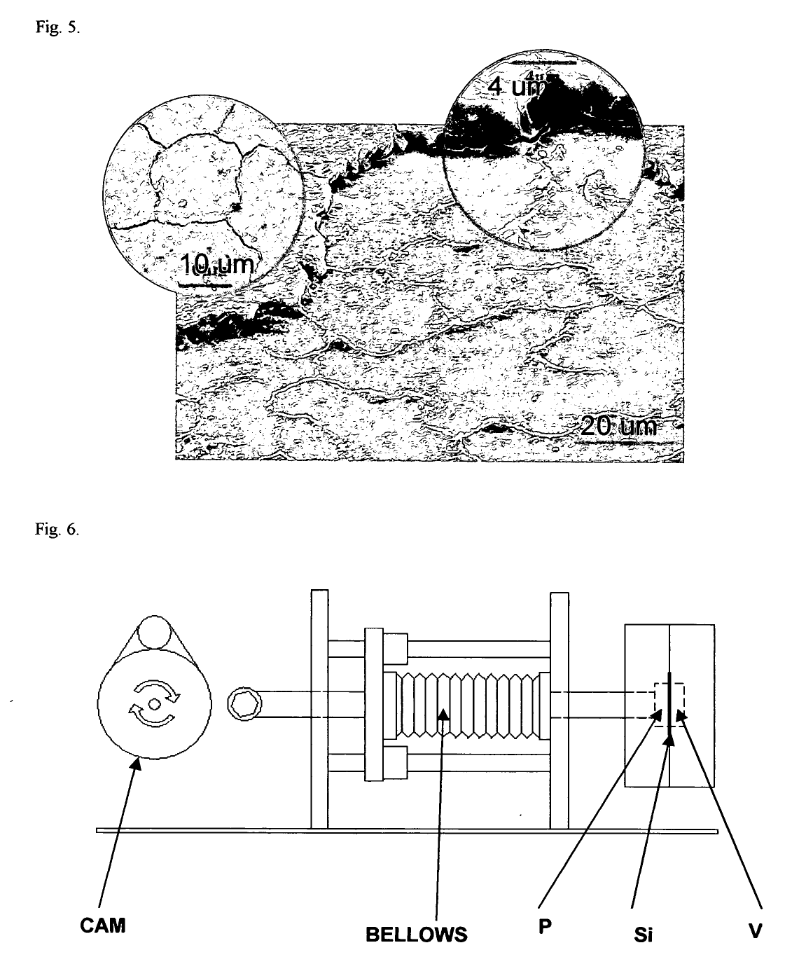

A silicon window that includes a SiF₄ passivation layer was exposed to 0.05% fluorine gas for 88 hours. This mimics the corrosion of uncoated silicon serving as a wall in a Kr—F₂ laser assembly, which forms SiF₄ as disclosed above. The window develops defects and fissures such as shown in FIG. 5. In order to inhibit such corrosion, silicon windows were coated by vacuum deposition with a film of a refractory material such as silicon nitride of thickness 500 nm. This provided the requisite corrosion resistance to the surface facing the laser gas mixture.

### Example 5

Corrosion Resistant Film.

A silicon window was coated for use in a Kr—F₂ laser assembly to provide corrosion resistance by vacuum deposition of carbon as nanocrystalline diamond. The diamond was deposited by magnetron sputtering, and formed a layer about 1.2 microns thick. A test chamber was evacuated and filled with 0.5% to 3% fluorine in argon gas. The test specimen was exposed for 72 hours to this gas mixture. The diamond coating was found to show no thinning from the exposure to fluorine. In addition the diffraction pattern in the diamond coating was unchanged.

### Example 6

Pressure Testing of a Silicon Window.

A planar silicon window without reinforcing ribs was exposed to repetitive cycles of pressurization to test its suitability for use in a laser apparatus of the invention. A pressure cycling apparatus was designed to mechanically model the KrF laser system. As shown in FIG. 6, a vacuum (V) is applied to one surface of the etched region of the window (Si). An initial pressure of approximately 1.3 to 2 atm (P) is placed on the other surface using the CAM and BELLOWS mechanism shown in the Figure, and cycled at 5 rev/sec. In this embodiment of an unreinforced window, the window survived cyclic pressurization between 1.0 atm and 1.3 atm at 5 Hz, as well as sustained monotonic pressure differential in this range. The monotonic pressure differential attained 1.5 atm before mechanical failure of the window.

### Example 7

Electron Transmission of a Silicon Window.

A planar silicon window 150 microns thick was exposed to repetitive pulsing in an electron beam similar to one that may be used to excite a lasing medium in the laser assembly of the present invention, in order to test the suitability of the window for use in the apparatus. In this Example there was no cooling, and the electron bombardment was carried out at 500 keV at a flux of 33.3 A/cm2, for 43 electron beam shots. The window survived without failure. The window used in this Example exhibited an electron transmission efficiency of 69%±5%.

### Example 8

Thermoelectric Cooling of a Window or Foil.

As shown in FIG. 2, a window 100 for use in a laser assembly of the invention is fashioned from a silicon semiconductor having appropriate P and N junctions incorporated such that when an electrical potential is imposed on the window, heat is displaced from the center of the window toward its periphery. In this way heat that builds up when an electron beam passes 5 through the central regions of the window is moved toward its edges. The central regions thereby maintain a temperature that is approximately equal to ambient temperature. The heat accumulating at the edges of the window is removed by circulation of a thermostating fluid around the periphery, for example in a closed recirculation system 200. The heated fluid circulated in tubing 220 is cooled at a location remote from the window by a cooling heat exchanger 240 incorporated into the recirculation system, and then returned to the window edge for further extraction of excess heat.

### Example 9

Cooling of a Window or Foil by Means of a Gas.

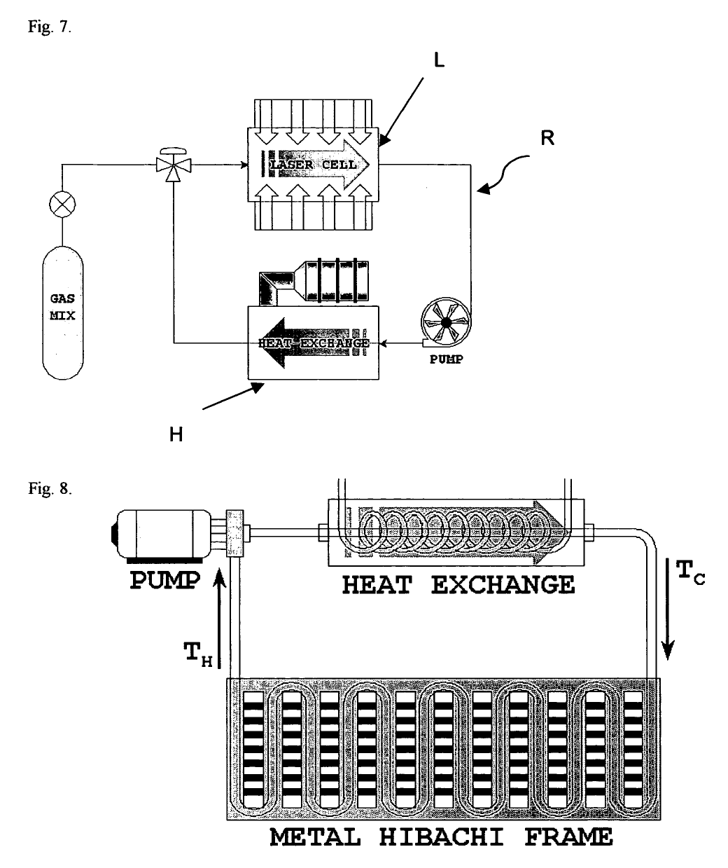

In the laser assembly of the present invention (see FIG. 7, L) the lasing medium is a gas mixture that includes Kr and F₂ in an argon carrier. In this example the gas mixture is transported in a closed recirculation system R. Since the window is a component of the wall of the laser assembly, the gas is in direct contact with the window. The gas therefore absorbs excess heat from the window as the electron beam is operated. The gas is recirculated for cooling through a remote heat exchanger H that is part of the recirculation system, and then returned to the laser cavity for lasing activity and further cooling of the window.

### Example 10

Cooling of a Window or Foil by a Circulating Liquid.

The window of the invention may be cooled by circulating a cooling liquid over the face of the window. In the window design for one embodiment of this method (see FIG. 8), a window has a thermally conducting framework, termed a Hibachi frame, superimposed on the window itself. In addition to providing mechanical support for the window as it is subjected to the cyclic pressure differentials envisioned in the operation of a laser assembly, the framework houses a portion of a closed recirculation system for the circulation of a cooling liquid. The tubing of the recirculation system is directly deposited on the Hibachi framework such that it is in thermal contact with the window. As the liquid passes through the tubing the liquid absorbs the excess heat developed within the window. The excess heat is in turn removed by a remote heat exchanger, thus returning cooled liquid to the face of the window.

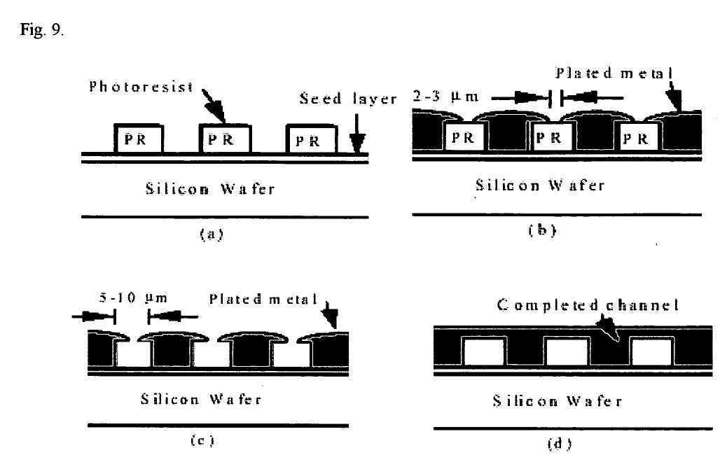

An alternative embodiment of a system of the invention cooled by circulating liquid is shown in FIG. 9. In this embodiment microchannels for circulating a cooling liquid over a window are etched directly onto the material of the window. Panels (a) through (d) of FIG. 9 show various stages of the construction of the channels. In panel (a), deposition of photoresists PR which will represent the cavities of the channels is carried out, onto a seed layer that overlays the window. In panel (b), metal is plated around and over the photoresists, leaving a small gap. In panel (c) the photoresist material is removed, leaving a partially finished channel. In panel (d) the microchannels are closed over, leaving the completed circulation channels on the surface of the window. The microchannels are then connected to a closed recirculation system, filled with liquid, and operated as described in the preceding paragraph.

### Example 11

Cooling by Vaporization of a Volatile Liquid.

The window or foil may be cooled by vaporizing a volatile liquid, using the excess heat developed in the window to provide the heat required to vaporize the liquid. An embodiment of a window coolable by liquid vaporization includes spray nozzles that deliver droplets of the volatile liquid to a surface of the window. The volatile liquid is sprayed through the nozzles at the window surface, which is cooled as the liquid vaporizes. The vapor may be collected at a remote location, cooled and condensed back to the liquid state, and reused for spraying.

We claim:

1. An energy-transmitting system comprising a nonmetallic window having at least two window surfaces and at least one edge, wherein the window transmits energy impinging on a first window surface and exiting from a second window surface, and means for cooling the window.

2. The system described in claim 1 wherein the energy comprises an atomic particle or a subatomic particle.

3. The system described in claim 2 wherein the particle is chosen from the group consisting of a beta particle, an electron, a proton, a neutron, and an alpha particle, or any combination of two or more of them.

4. The system described in claim 1 wherein the energy comprises electromagnetic radiation.

5. The system described in claim 1 wherein the window comprises a dielectric material.

6. The system described in claim 1 wherein the window comprises a semiconducting material.

7. The system described in claim 6 wherein the semiconducting material comprises silicon.

8. The system described in claim 1 further comprising a corrosion-resistant coating deposited on at least one window surface.

9. The system described in claim 8 wherein the coating comprises silicon nitride or carbon.

10. The system described in claim 1 wherein the window sustains a pressure differential imposed between a first window surface and a second window surface.

11. The system described in claim 10 wherein the pressure differential is about 2 atmospheres or less.

12. The system described in claim 1 wherein the window comprises a semiconductor exhibiting a thermoelectric effect and the cooling means comprises a source of an electrical potential connected to a positive electrode and to a negative electrode, wherein a positive electrode is further connected to at least a first edge of the window effectively to impose a positive potential thereon and a negative electrode is further connected to at least a second edge of the window effectively to impose a negative potential thereon.

13. The system described in claim 12 wherein the cooling means further comprises means for removing heat from an edge of the window.

14. The system described in claim 1 wherein the cooling means comprises a cooling fluid in flowing contact with a window surface and means for impelling flow of the fluid across the window surface.

15. The system described in claim 1 wherein the cooling means comprises a closed channel traversing the window, a cooling fluid flowing within the channel, and means for impelling the flow of the fluid through the channel.

16. The system described in claim 1 wherein the cooling means comprises a vaporizable liquid contacting a window surface and means for impelling the liquid onto the window surface.

17. A method of cooling the window of the energy-transmitting system described in claim 1, comprising providing the system, and operating the cooling means disposed effectively to cool the window.

18. A method of cooling the window of the energy-transmitting system described in claim 12 comprising imposing a positive potential on a first edge of the window using the positive electrode and imposing a negative potential on a second edge of the window using the negative electrode.

19. The method described in claim 18 further comprising removing heat from an edge of the window.

20. The method described in claim 17 wherein operating the cooling means comprises impelling a cooling fluid into contact with a window surface.

21. The method described in claim 20 wherein the cooling fluid is a gas.

22. The method described in claim 20 wherein the cooling fluid is a vaporizable liquid.

23. The method described in claim 17 wherein the cooling means comprises a closed channel traversing the window, and wherein the operating comprises impelling the flow of a cooling fluid through the channel.

24. A laser assembly comprising a laser cavity enclosed by a wall comprising one or more wall surfaces, the cavity enclosing a lasing medium, and further comprising an energy-transmitting system described in claim 1 wherein at least one wall surface comprises a window of the system.

25. The assembly described in claim 24 wherein the energy comprises an atomic particle or a subatomic particle.

26. The assembly described in claim 25 wherein the particle is chosen from the group consisting of a beta particle, an electron, a proton, a neutron, and an alpha particle, or any combination of two or more of them.

27. The assembly described in claim 24 wherein the energy comprises electromagnetic radiation.

28. The assembly described in claim 24 wherein the window comprises a dielectric material.

29. The assembly described in claim 24 wherein the window comprises a semiconducting material.

30. The assembly described in claim 29 wherein the semiconducting material comprises silicon.

31. The assembly described in claim 24 wherein the window further comprises a corrosion-resistant coating deposited on at least one window surface.

32. The assembly described in claim 31 wherein the coating comprises silicon nitride or carbon.

33. The assembly described in claim 24 wherein the window sustains a pressure differential imposed between a first window surface and a second window surface.

34. The assembly described in claim 33 wherein the pressure differential is about 2 atmospheres or less.

35. The assembly described in claim 24 wherein the window comprises a semiconductor exhibiting a thermoelectric effect and the cooling means comprises a source of an electrical potential connected to a positive electrode and to a negative electrode, wherein a positive electrode is further connected to at least a first edge of the window effectively to impose a positive potential thereon, and wherein a negative electrode is further connected to at least a second edge of the window effectively to impose a negative potential thereon.

36. The assembly described in claim 35 wherein the system further comprises means for removing heat from an edge of the window.

37. The assembly described in claim 24 wherein the cooling means comprises a cooling fluid in flowing contact with a window surface and means for impelling flow of the fluid across the window surface.

38. The assembly described in claim 24 wherein the cooling means comprises a closed channel traversing the window, a cooling fluid flowing within the channel, and means for impelling the flow of the fluid through the channel.

39. The assembly described in claim 24 wherein the cooling means comprises a vaporizable liquid contacting a window surface and means for impelling the liquid onto the window surface.

40. A method of cooling a window comprised in a laser assembly of claim 24, the method comprising providing the assembly and operating a cooling means disposed effectively to cool the window.

41. A method of cooling a window comprised in a laser assembly of claim 35 comprising imposing a positive potential on a first edge of the window using the positive electrode and imposing a negative potential on a second edge of the window using the negative electrode.

42. The method described in claim 41 further comprising removing heat from an edge of the window.

43. The method described in claim 40 wherein operating the cooling means comprises impelling a cooling fluid into contact with a window surface.

44. The method described in claim 43 wherein the cooling fluid is a gas.

45. The method described in claim 43 wherein the cooling fluid is a vaporizable liquid.

46. A method described in claim 40 wherein the cooling means comprises a closed channel traversing the window, and wherein the operating comprises impelling the flow of a cooling fluid through the channel.
